(19) United States
(12) Patent Application Publication
(10) Pub. No.: US 2014/0062340 A1
(43) Pub. Date: Mar. 6, 2014

(54) Electrical Switch Device with Automatic Control

(71) Applicant: Ahmed Elgayyar, Senoia, GA (US)

(72) Inventor: Ahmed Elgayyar, Senoia, GA (US)

(21) Appl. No.: 13/600,500

(22) Filed: Aug. 31, 2012

(51) Int. Cl. H05B 37/02

(52) U.S. Cl. 315/360

(57) ABSTRACT

The electrical switch device can operate a lighting device when a user is not present. The electrical switch device can include a housing having a number of walls forming a cavity. The electrical switch device can also include a controller positioned within the cavity and used to operate a lighting device. The electrical switch device can further include a storage repository that stores a usage history for the lighting device and memory to store instructions. The electrical switch device can further include a timer that tracks time and a hardware processor for executing the instructions, where the hardware processor is operatively coupled to the memory, the timer, and the controller. The electrical switch device can also include a control switch that has an enabled state and a disabled state, where the enabled state allows the hardware processor to control the controller based on the usage history.

### TECHNICAL FIELD

The present disclosure relates generally to a light control device, and more particularly to a light control device used to automatically control lighting, fan, and/or other electrical functions.

### BACKGROUND

When a living space is left vacant for some period of time, there are signs, when viewed from the exterior of the living space, that the living space is unoccupied. For example, there may be no lights on inside, the television isn't running, or a computer monitor may not be in use. In such a case, someone intending to commit burglary or some similar crime may target such a living space. Alarm systems can be used to alert to an intruder, but there is a delay from when the alarm sounds and when a responder arrives at the scene.

As for electronic devices (e.g., lights, televisions, computers) inside the home, a timer can be used for individual devices, but such timers can be cumbersome to set up and install for use. For example, for a table lamp that is connected to an outlet positioned behind a couch, the couch needs to be moved to install the timer. As another example, human error (e.g., setting the timer for a.m. instead of p.m., inserting the tabs in the wrong slots) can cause the timer to operate at undesired times.

### SUMMARY

In general, in one aspect, the disclosure relates to an electrical switch device. The electrical switch device can include a housing having a number of walls forming a cavity. The electrical switch device can also include a controller positioned within the cavity and used to operate at least one lighting device external to the housing. The electrical switch device can further include a storage repository that stores a usage history for the at least one lighting device, as well as memory positioned within the cavity, where the memory stores a plurality of instructions. The electrical switch device can also include a timer that tracks time, as well as a hardware processor for executing the instructions stored in the memory, where the hardware processor is positioned within the cavity and is operatively coupled to the memory, the timer, and the controller. The electrical switch device can further include a control switch operatively coupled to the controller and the hardware processor, where the control switch has an enabled state and a disabled state, where the enabled state allows the hardware processor to control the controller based on the usage history, and where the disabled state allows the controller to be controlled by a user.

In another aspect, the disclosure can generally relate to a method for controlling a lighting device. The method can include tracking a usage of the lighting device, and compiling, based on the usage, a usage history of the lighting device. The method can also include receiving an enablement signal from a user, and operating, using a hardware processor, and based on the enablement signal, the lighting device according to the usage history.

In yet another aspect, the disclosure can generally relate to a computer readable medium comprising computer readable program code embodied therein for performing a method for controlling a lighting device. The method can include tracking a usage of the lighting device, and compiling, based on the usage, a usage history of the lighting device. The method can also include receiving an enablement signal from a user, and operating, using a hardware processor, and based on the enablement signal, the lighting device according to the usage history.

These and other aspects, objects, features, and embodiments will be apparent from the following description and the appended claims.

### BRIEF DESCRIPTION OF THE DRAWINGS

The drawings illustrate only exemplary embodiments of an electrical switch device with automatic control and are therefore not to be considered limiting of its scope, as the electrical switch device with automatic control may admit to other equally effective embodiments. The elements and features shown in the drawings are not necessarily to scale, emphasis instead being placed upon clearly illustrating the principles of the exemplary embodiments. Additionally, certain dimensions or positionings may be exaggerated to help visually convey such principles. In the drawings, reference numerals designate like or corresponding, but not necessarily identical, elements.

FIG. 1 shows a diagram of an exemplary system for use in incorporating the electrical switch device with automatic control in accordance with one or more exemplary embodiments.

FIGS. 2, 2A, 2B, 2C-1, and 2C-2 show various views of an exemplary electrical switch device with automatic control in accordance with one or more exemplary embodiments.

FIG. 3 shows a flowchart of an exemplary method for controlling a lighting device in accordance with one or more exemplary embodiments.

FIG. 4 shows a computer system in accordance with one or more exemplary embodiments.

FIG. 5 shows an example using an exemplary electrical switch device in accordance with one or more exemplary embodiments.

### DETAILED DESCRIPTION OF EXEMPLARY EMBODIMENTS

Exemplary embodiments of an automatic switch device (also simply called a “device” and/or an “electrical switch device” herein) for use during the absence of a user will now be described in detail with reference to the accompanying figures. Like elements in the various figures are denoted by like reference numerals for consistency. In the following detailed description of the exemplary embodiments, numerous specific details are set forth in order to provide a more thorough understanding of the disclosure herein. However, it will be apparent to one of ordinary skill in the art that the exemplary embodiments herein may be practiced without these specific details. In other instances, well-known features have not been described in detail to avoid unnecessarily complicating the description.

The electrical switch device described herein may include one or more of a number of different types of electric switching devices. For example, an electrical switch device may be a dimmer, a switch (e.g., a light switch), a sensor (e.g., a motion sensor), some other suitable device, or any combination thereof. An electrical switch device can be in-wall (i.e., mounted in an aperture in a surface, such as a wall or a ceiling), stand-alone, or be used in any other type of setting.

If the electrical switch device is used in an in-wall application, then the electrical switch device described herein may, at least in part, be mechanically coupled to a wall by being mounted within and/or behind the wall. As defined herein, a wall is any type of building material (e.g., drywall, ceiling tiles, brick, plywood, wall studs, cement, cinder blocks) that is used to create a surface (e.g., wall, ceiling, floor) that defines a structure or a space (e.g., room, duct) within a structure. A wall may also include some other object (e.g., a mounting plate, a junction box) adjacent to building material. The surface may be located within the structure or outside the structure. The surface may be in an open area or in an enclosed area.

In one or more exemplary embodiments, an electrical switch device is used with a single gang junction box. In such a case, exemplary embodiments of an electrical switch device typically meet the standards of a National Electrical Manufacturer's Association (NEMA) 1 enclosure. Alternatively, exemplary electrical switch device described herein may also be used with multiple (e.g., two, three, four) gang junction boxes. In such a case, exemplary embodiments of an electrical switch device typically meets the standards set by NEMA, and/or any other appropriate standard-setting entity, for such an enclosure.

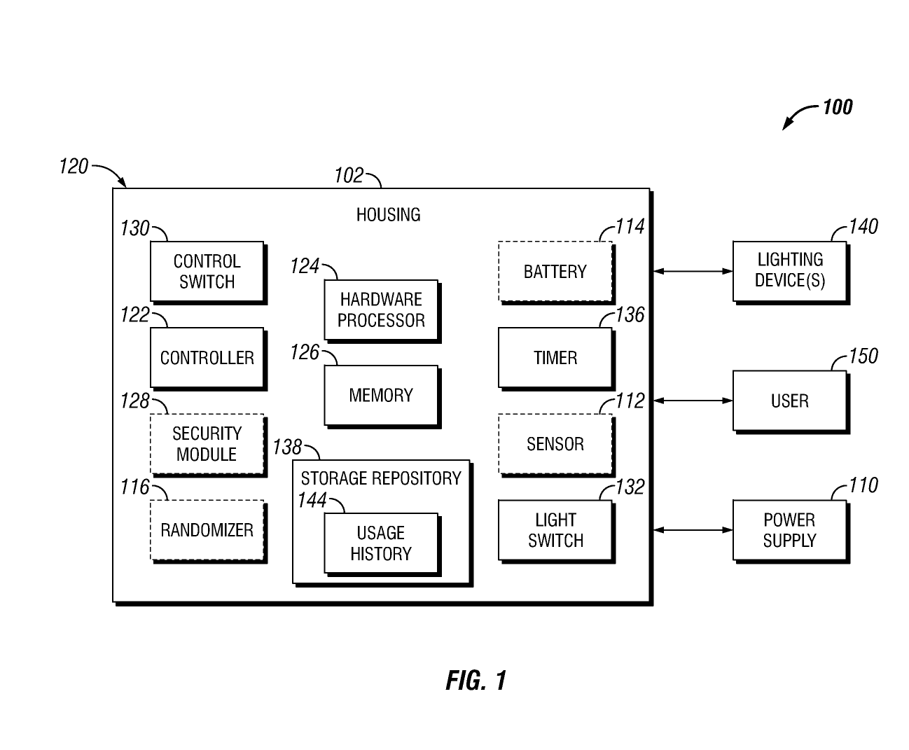

FIG. 1 shows a diagram of a system 100 for use with an electrical switch device in accordance with one or more exemplary embodiments. Referring now to FIG. 1, the exemplary system 100 includes a power supply 110, an electrical switch device 120, one or more lighting devices 140, and a user 150. In one exemplary embodiment, the electrical switch device 120 includes a housing 102 that houses (or has disposed thereupon) a controller 122, a hardware processor 124, memory 126, a control switch 130, a light switch 132, a timer 136, a storage repository 138, and, optionally, a sensor 112, a battery 114, a randomizer 116, and a security module 128. Each of these components is described below. Exemplary embodiments are not limited to the configuration shown in FIG. 1 and discussed herein.

Referring to FIG. 1, the exemplary power supply 110 is one or more sources of energy (e.g., electricity) used to provide power and/or control to the electrical switch device 120 and, at times, the one or more lighting devices 140 through the electrical switch device 120. The power supply 110 typically provides electricity that is in alternating current (AC) format and/or direct current (DC) format. The power supply 110 can be physically separate from the electrical switch device 120 (as with 120VAC household wiring that is connected to the electrical switch device 120) and/or internal within the electrical switch device 120 (as with the optional battery 114).

The amount of voltage delivered by the power supply 110 to the electrical switch device 120 may be any amount suitable to operate the elements of the electrical switch device 120. In certain exemplary embodiments, the voltage delivered by the power supply 110 is transformed, rectified, inverted, and/or otherwise manipulated, at the power supply 110 and/or within the electrical switch device 120, so that the various components of the electrical switch device 120 receive a proper voltage and/or current level to operate properly.

In one or more exemplary embodiments, the electrical switch device 120 controls one or more lighting devices 140. For example, the electrical switch device 120 receives an interaction (e.g., a manual manipulation of the control switch 130) from the user 150 and, in response, generates and sends one or more instructions based on the interaction received from the user 150. In addition, or in the alternative, the electrical switch device 120 can receive information from one or more lighting devices 140 and/or the controller 122 (or portions thereof). In response in such a case, the electrical switch device 120 generates and sends one or more instructions based on the interaction received from the one or more lighting devices 140 and/or the controller 122.

One or more of a number of components (e.g., the controller 122, the hardware processor 124, the memory 126, the control switch 130, the storage repository 138) of the electrical switch device 120 are used to perform the various functions of the electrical switch device 120. Such components may be discrete components, part of a semiconductor, and/or part of a software-based control circuit.

In one or more exemplary embodiments, the electrical switch device 120 is implemented according to a client-server topology. The electrical switch device 120 can correspond to enterprise software running on one or more servers, and in some embodiments may be implemented as a peer-to-peer system, or resident upon a single computing system. In additional exemplary embodiments, the electrical switch device 120 is accessible from other machines using one or more application programming interfaces and/or user interfaces (not shown). In one or more exemplary embodiments, the electrical switch device 120 is accessible over a network connection (not shown), such as the Internet, by one or more users (e.g., user, data source, image capture device). Further, information and/or instructions received and/or generated by the electrical switch device 120 may also be stored and accessed over the network connection.

Alternatively or additionally, in one or more exemplary embodiments, the electrical switch device 120 is a local computer system of the user 150. In such embodiments, the electrical switch device 120 may, optionally, not be implemented using a client-server topology. For example, the electrical switch device 120 may correspond to a portable computer, mobile device, another type of computing device, and/or combination of multiple computing devices. Additionally or alternatively, the electrical switch device 120 may be a distributed computer system and/or multi-processor computer system that includes multiple distinct computing devices.

In certain exemplary embodiments, the electrical switch device 120 is coupled to an outlet box, as may be used, for example, by a wall-mounted light switch. The electrical switch device 120 may be wireless, detachable, and/or portable. In exemplary embodiments, the electrical switch device 120 operates as a remote control device. In such a case, the device 120 includes one or more components (e.g., transceiver) configured to allow signals to be sent and/or received wirelessly. Further, in such a case, the electrical switch device 120 can be made of two or more components that are detatchable (removable) from/attachable to each other.

The detachable components of the electrical switch device 120 may detach/attach using one or more of a number of fastening mechanisms, including but not limited to a spring catch and release, a snap, a slotted receiver, mating threads, and a clamp. When a portion of the electrical switch device 120 is detached, the detached components may communicate with each other as long as such components remain within a certain distance of each other. Such a distance will depend on one or more of a number of factors, including but not limited to the wireless technology being used.

In certain exemplary embodiments, the electrical switch device 120 includes a housing 102, inside of which one or more components (e.g., controller 122, hardware processor 124, timer 136) of the electrical switch device 120 are located. Alternatively, one or more components of the electrical switch device 120 can be located outside of the housing 102 but operatively coupled (using wired and/or wireless technology) to one or more other components of the electrical switch device 120 that are located inside of the housing 102. The housing 102 can be made of one or more of a number of suitable materials, including but not limited to plastic, metal, glass, nylon, and rubber.

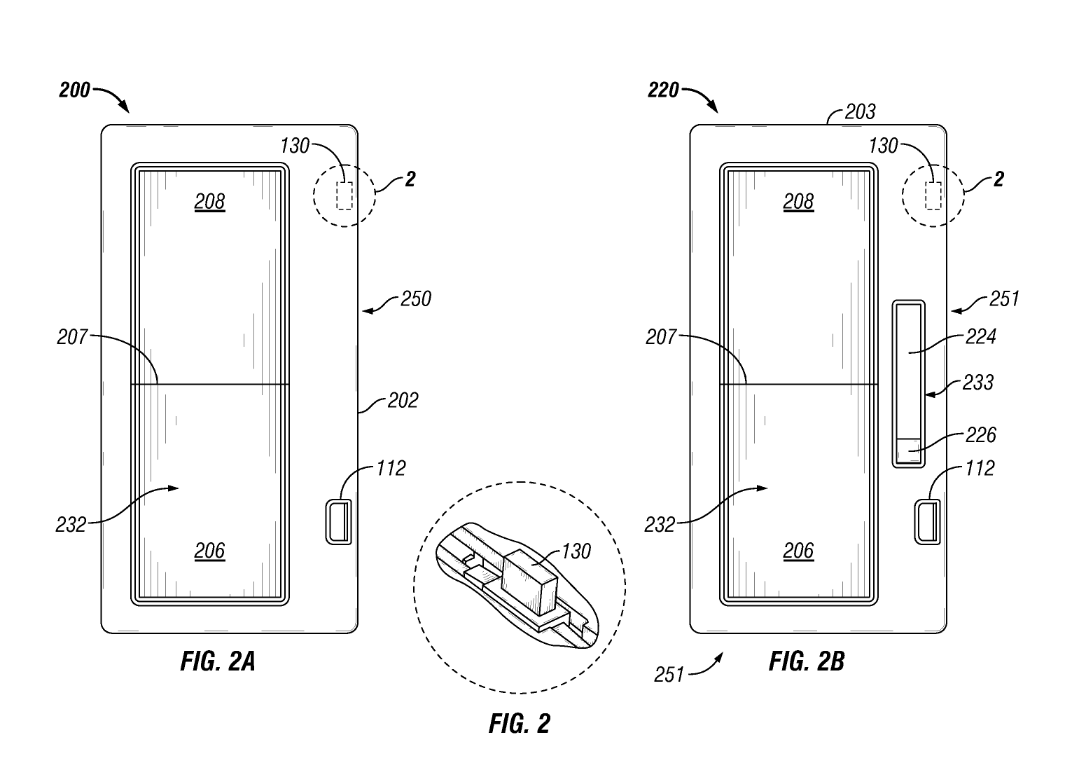

The housing 102 can include one or more of a number of components, including but not limited to a wall plate and a mounting strap. The housing 102 and its components are discussed below in more detail with respect to FIGS. 2A-C. The components positioned inside of or on a surface of the housing 102 can vary based on one or more of a number of factors, including but not limited to the size of the housing 102 and the lighting devices 140 that are being controlled by the electrical switch device 120.

Continuing with reference to FIG. 1, the exemplary electrical switch device 120 is configured to receive instructions from the user 150 and track the usage of each lighting device 140. More specifically, the controller 122 of the electrical switch device 120 receives instructions from the user 150, monitors the usage of a lighting device 140, stores the usage of a lighting device 140 in the storage repository 138, compiles a usage history 144 of a lighting device 140 in the storage repository 138, and determines a current usage based on the usage history 144 of the lighting device 140, all in accordance with one or more exemplary embodiments.

In certain exemplary embodiments, the control switch 130 of the electrical switch device 120 is communicably coupled to the hardware processor 124. The control switch 130 is enabled when a particular setting on the control switch 130 is received. The control switch 130 has an enabled state and a disabled state. The control switch 130, when in the enabled state, allows the hardware processor 124 to control the controller 122. When in the disabled state, the control switch 130 allows the controller 122 to be controlled by a user 150 and/or the sensor 112.

As a specific example, the control switch 130, when enabled, instructs the hardware processor 124 (sends an enablement signal) to control the controller 122 (discussed more fully below) according to a usage history 144 compiled by the hardware processor 124 and stored in the storage repository 138. In such a case, the timer 136 notifies the hardware processor 124 as to the time of day so that the usage history 144 is put into a proper time perspective. If the usage history 144 shows that a lighting device 140 controlled by the controller 122 is normally turned on at that particular time of day (as evidenced by the timer 136), and if the lighting device 140 is currently off, then the hardware processor 124 commands the controller 122 to send a signal to the lighting device 140 to turn on. As another specific example, if the usage history 144 shows that the lighting device 140 controlled by the controller 122 is normally turned off at that particular time of day (as evidenced by the timer 136), and if the lighting device 140 is currently on, then the hardware processor 124 commands the controller 122 to send a signal to the lighting device 140 to turn off.

In certain exemplary embodiments, the control switch 130 functions as a toggle switch between enabling the hardware processor 124 to control (based on the usage history 144 and using the controller 122) when the lighting device 140 is turned on/off and enabling a user 150 and/or a sensor 112 to control when the lighting device 140 is turned on/off. In addition, the control switch 130 (which may be a different part of the control switch 130, or a different switch that is also communicably coupled to the hardware processor

124) can also enable the randomizer 116 (discussed more fully below). In certain exemplary embodiments, the randomizer 116 can only be enabled by the control switch 130 when the control switch 130 is in the enabled state.

When the controller 122 controls more than one lighting device 140, the control switch 130 can also include one or more features that allow a user 150 to select which of the lighting devices 140 are controlled by the controller 122 when the control switch 130 is in the enabled state. For example, the control switch 130 can have a number of two-pole dual in-line package (DIP) switches, where each DIP switch corresponds to one of the lighting devices 140. As another example, the user 150 can select certain lighting devices 140 on an application interface, which serves as a virtual control switch 130. In certain exemplary embodiments, instructions delivered by the user 150 to the controller 122 when the control switch 130 is in the enabled state supersede instructions delivered by the hardware processor 124 to the controller 122 and/or instructions delivered by the randomizer 116 to the controller 122.

The exemplary control switch 130 can be any type of switch. For example, the control switch 130 can be a physical switch that is manually manipulated (e.g., enabled) by a user 150 at the housing 102. An example of a physical switch is a DIP switch. As another example, the control switch 130 can be a pushbutton that toggles between the enabled state and the disabled state each time that the pushbutton is depressed. In the case where the control switch 130 is a pushbutton, the pushbutton can toggle in one or more of a number of ways. For example, the pushbutton can be depressed past a certain point to lock the pushbutton in place in the enabled state, and subsequently pushed again later in time past the certain point to unlock from the enabled state to toggle to the disabled state. As another example, the pushbutton can be depressed past a certain point and held in that position for some period of time (e.g., three seconds) to change states from enabled to disabled or from disabled to enabled.

In certain exemplary embodiments, the control switch 130 can be combined with some other switch, pushbutton, or other feature on the outer surface of or inside of the housing 102. For example, if a sliding dimmer switch is disposed on the front surface of the housing 102, the slider can be depressed for four seconds to toggle the control switch 130 between the enabled state and the disabled state.

Alternatively, or in addition, the control switch 130 can be program instructions (e.g., software, firmware) that are hardcoded and/or adjustable. The program instructions can be adjustable automatically, manually, and/or based on the occurrence of certain conditions. Such program instructions may reside on and/or be executed by the hardware processor 124. The control switch 130 is typically located within the housing 102 or disposed on an outer surface (e.g., face plate) of the housing 102, but the control switch 130 can also be located remotely from the housing 102 and communicably coupled to the electrical switch device 120.

In certain exemplary embodiments, the light switch 132 of the electrical switch device 120 is communicably coupled to the controller 122. Specifically, the light switch 132 can send a signal to the controller 122 to turn the lighting device 140 on and/or off. The light switch 132 is enabled when a particular setting on the light switch 132 is received from a user 150. The light switch 132 can be any type of switch having any of a number of settings. Examples of a light switch 132 can include a bipolar switch having two settings (e.g., on and off), a multi-pole switch having more than three settings (e.g., high, low, medium, and off), and a sliding switch having a number of discrete or continuous settings (as with a dimmer). The light switch 132 can have more than one capability. For example, a single light switch can turn a light on/off, adjust the light using a dimmer, turn a ceiling fan on/off, and adjust a speed of the ceiling fan.

The light switch 132 may override the control switch 130. For example, when the control switch 130 is in the enabled state and the light switch 132 is in the off position, if the light switch 132 is turned on, then the lighting device 140 is turned on. Such can be the case even if the usage history 144 of the lighting device 140 dictates that the lighting device 140 should be off at that time of day while the control switch 130 is in the enabled state. As another example, when the control switch 130 is in the enabled state and the light switch 132 is in the off position, the usage history 144 dictates that the lighting device 140 is turned on at a 50% dimming level. If the user then adjusts the dimmer light switch 132 to a 25% dimming level, then the lighting device 140 is dimmed to the 25% dimming level.

In other words, in certain exemplary embodiments, changing a position of the light switch 132 can toggle the control switch 130 from the enabled state to the disabled state. Alternatively, changing the setting of the light switch 132 while the control switch 130 is in the enabled state can keep the control switch 130 in the enabled state, but allow the new setting of the light switch 132 to determine the output to the lighting device 140 until the usage history 144, for the subsequent time of day as determined by the timer 136, dictates that the hardware processor 124, using the controller 122, changes the state of the lighting device 140.

The exemplary light switch 132 can be any type of switch. For example, the light switch 132 can be a physical switch that is manually manipulated (e.g., enabled) by a user 150 at the housing 102. An example of a physical switch is a DIP switch. As another example, the light switch 132 can be a pushbutton that toggles between on and off each time that the pushbutton is depressed. Alternatively, or in addition, the light switch 132 can be program instructions (e.g., software, firmware) that are hardcoded and/or adjustable. The program instructions can be adjustable automatically, manually, and/or based on the occurrence of certain conditions. Such program instructions may reside on and/or be executed by the hardware processor 124. The light switch 132 is typically disposed on an outer surface (e.g., face plate) of the housing 102, but the light switch 132 can also be located remotely from the housing 102 and communicably coupled to the electrical switch device 120.

In one exemplary embodiment, the controller 122 is configured to send information (e.g., data, instructions, signals) to and/or retrieve information (e.g., data, interactions) from memory 126, the timer 136, the storage repository 138, the hardware processor 124, the control switch 130, the security module 128, any other components of the electrical switch device 120, the power supply 110, the user 150, and/or the lighting devices 140. Specifically, in certain exemplary embodiments, the controller 122 is configured to receive an interaction, originated by the user 150, from the control switch 130. The interaction received by the controller 122 from the control switch 130 may be of any suitable form, including but not limited to a pressure pulse, an electrical signal, and a digital code.

The exemplary controller 122 is further configured to control, based on the control switch 130 being in the enabled state, the usage history 144 stored in the storage repository 138, and/or the time kept by the timer 136, the one or more lighting devices 140. Specifically, the controller 122 receives a signal from the control switch 130 that the control switch 130 is in the enabled state. Subsequently, based on instructions stored in memory 126, the controller 122 interprets the usage history 144 received from the storage repository 138 based on the time of day received from the timer 136 and generates, if necessary, a corresponding signal to the appropriate lighting device 140. The controller 122 also may determine, based on the lighting device 140 and the usage history 144, the appropriate form and/or level for the signal used to control the lighting device 140.

In addition, if the randomizer 116 is enabled while the control switch 130 is in the enabled state, the randomizer 116 may override the usage history 144 stored in the storage repository 138 and instructs the controller 122 to operate the lighting device 140 at some random times and for some random durations. In such a case, at some point in time after the randomizer 116 instructs the controller 122 to operate (turn on) the lighting device 140, the randomizer 116 instructs the controller 122 to turn off the lighting device 140.

Examples of controlling a lighting device 140 by the controller 122 include, but are not limited to, sending voltage and/or current to turn on the lighting device 140, stopping voltage and/or current to turn off the lighting device 140, adjusting voltage and/or current to (as with a dimmer selection) to adjust an amount of output for the lighting device 140 (e.g., light fixture, ceiling fan), setting a timer for the lighting device 140, and flipping a switch to change a mode of operation (e.g., changing the direction of a ceiling fan) for the lighting device 140. In certain exemplary embodiments, the controller 122 also controls each lighting device 140 using hard wires and/or using wireless technology. The controller 122 may be embodied in one or more of a number of forms, including but not limited to a microcontroller, a programmable logic controller, and a programmable gate array.

In exemplary embodiments, the one or more lighting devices 140 are any type of light fixture (e.g., a table lamp, a ceiling light, a wall light, a night light). A lighting device 140 may also include devices that may be integrated with a light, including but not limited to a ceiling fan (with or without an attached light). A lighting device 140 may also include other devices that control an electrical load. For example, a lighting device 140 may include a thermostat. Those skilled in the art will appreciate that a lighting device 140 may also be associated with other electronic devices (e.g., television, stereo, speakers) that may be controlled, directly or indirectly, by an electrical switch device 120. For example, exemplary embodiments may be used to control a downstream receptacle in which one or more electrical appliances are connected. Each lighting device 140 can be configured to communicate with the controller 122 using wired and/or wireless technology.

The user 150 interacts with the electrical switch device 120. Specifically, the user 150 sends commands to the electrical switch device 120 by, for example, moving a dimmer switch on the electrical switch device 120 form one position to a different position, turning a light switch on the electrical switch device 120 “on” or “off”, toggling the control switch 130 between the enabled state and the disabled state, and using the control switch 130 to enable or disable the randomizer 116.

The user 150 is capable of interacting with the electrical switch device 120 using one or more of a number of touching instruments, including, but not limited to, a finger, a stylus, a cursor of a mouse, and a key on a keypad. The user 150 is capable of interacting with the electrical switch device 120 in person (e.g., physically touching the control switch 130 on or inside the housing 102 with a finger) or virtually (e.g., touching a portion of a graphical user interface (GUI) on an application of a computing device, which virtually changes a state of the control switch 130). The user 150 may be a homeowner, a business owner, a tenant, a landlord, an agent, an administrator, an energy manager, a consultant, a representative of the owner, or some other entity that manages one or more lighting devices 140 controlled by the electrical switch device 120.

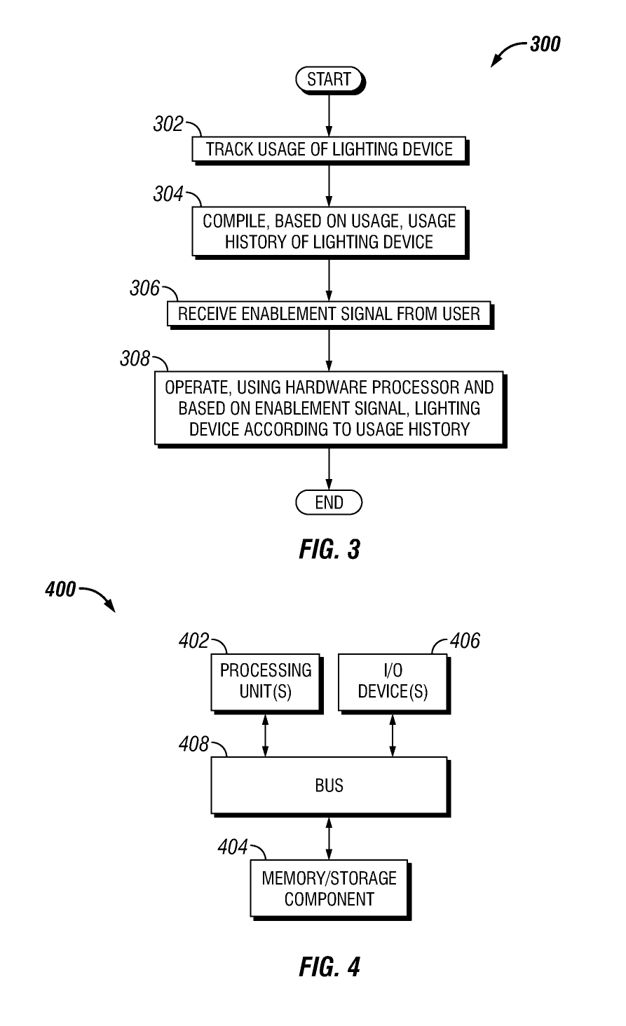

In one or more exemplary embodiments, the user 150 uses a user system that operates using user software. The exemplary user system is, or may contain a form of, an Internet-based or an intranet-based computer system that is capable of communicating with the user software. A user system may include any type of computing device and/or communication device, including but not limited to the electrical switch device 120. Examples of the user system include, but are not limited to, a laptop computer with Internet or intranet access, a smart phone, a server, a server farm, and a personal digital assistant (PDA). In certain exemplary embodiments, the user system corresponds to a computer system as described below with regard to FIG. 4.

The user software may execute on the electrical switch device 120 and/or a separate device (e.g., a server, mainframe, desktop personal computer (PC), laptop, personal desktop assistant (PDA), television, cable box, satellite box, kiosk, telephone, mobile phone, or other computing devices) from the electrical switch device 120. In certain exemplary embodiments, the device on which the user software executes is coupled by a network (e.g., Internet, intranet, extranet, Local Area Network (LAN), Wide Area Network (WAN), or other network communication methods), with wired and/or wireless segments. The user software may also be part of, or operate separately from but in conjunction with, the electrical switch device 120.

The exemplary storage repository 138 is a persistent storage device (or set of devices) that stores software and data used to control one or more lighting devices 140. The storage repository 138 may store any type of suitable data associated with the lighting devices 140, including but not limited to usage history 144, operational data, formulas, manufacturing data, and nameplate data. Examples of a storage repository 138 include, but are not limited to, a database (or a number of databases), a file system, a hard drive, some other form of data storage, or any suitable combination thereof.

The storage repository 138 may be located on multiple physical machines, each storing all or a portion of the usage information, usage history 144, calculations, algorithms, instructions, and/or any other suitable information. Each storage unit or device may be physically located in the same or different geographic location, which may be within or outside of the housing 102 of the electrical switch device 120.

In certain exemplary embodiments, the storage repository 138 stores the usage history 144 of a lighting device 140. The usage history 144 tracks the usage of a particular lighting device 140 controlled by the controller 122 and/or light switch 132. The usage history 144 can be stored in terms of clock time kept by the timer 136.

The storage repository 138 can also store one or more algorithms, used by the hardware processor 124, which are used to control when a lighting device 140 is turned on and off when the control switch 130 is enabled. Each algorithm can be based on a recent number of usages in the usage history 144 (e.g., a simple average of the last ten usages in the usage history 144 for a lighting device 140), based on the time of day (e.g., if the usage period is between 6 a.m. and 11 p.m., the straight average of the fifteen most recent usages in the usage history 144 are weighted 60% and the straight average of the remaining usages in the usage history 144 are weighted 40%), based one or more other factors, or any combination thereof. In certain exemplary embodiments, the hardware processor 124 generates and/or modifies an algorithm to determine when a lighting device 140 is turned on and off when the control switch 130 is enabled.

The exemplary hardware processor 124 within the housing 102 of the electrical switch device 120 is configured to execute software in accordance with one or more exemplary embodiments. Specifically, the hardware processor 124 is configured to execute the instructions used to operate the electrical switch device 120, including any of its components, described above and shown in FIG. 1, as well as software used by the user 150 and/or the one or more lighting devices 140. The exemplary hardware processor 124 is an integrated circuit, a central processing unit, a multi-core processing chip, a multi-chip module including multiple multi-core processing chips, or other hardware processor. The hardware processor 124 may be known by other names, including but not limited to a computer processor, a microcontroller, a microprocessor, and a multi-core processor.

In one or more exemplary embodiments, the hardware processor 124 is configured to execute software instructions stored in memory 126. The exemplary memory 126 may include one or more cache memories, main memory, and/or any other suitable type of memory. In certain exemplary embodiments, the memory 126 is discretely located within the device 120 relative to the hardware processor 124. In certain configurations, the memory 126 may also be integrated with the hardware processor 124. The controller 122 and/or the hardware processor 124 may be integrated into one or more mixed signal integrated circuits. In such a case, the profile and/or cost of the controller 122 and/or hardware processor 124 may be reduced.

Optionally, in one or more exemplary embodiments, the security module 128 is configured to secure interactions between the electrical switch device 120 and the user 150 and/or lighting devices 140. More specifically, the exemplary security module 128 is configured to authenticate communication from software based on security keys verifying the identity of the source of the communication. For example, user software may be associated with a security key enabling the user 150 to interact with the electrical switch device 120. Further, the security module 128 may be configured to restrict interactions, the interactive templates displayed on the GUI, lighting devices 140 that can be accessed and/or controlled, and/or transmission of information (e.g., operating status of a light or fan), as well as access to other information. For example, the user 150 may be restricted to only select an enabled state of the control switch 130 for only certain lighting devices 140 associated with and/or approved for that specific user 150.

The timer 136 is operatively coupled to the controller 122. The timer 136 can be located within the housing 102 of the electrical switch device 120. Alternatively, the timer 136 can be located remotely from the housing 102. The timer 136 can be a physical device, a circuit that includes one or more of a number of discrete components (e.g., resistor, capacitor), an integrated circuit, software (as executed by the hardware processor 124, for example), or any suitable combination thereof.

In exemplary embodiments, a timer 136 of the electrical switch device 120 is configured to keep clock time and/or track one or more periods of time (e.g., track a running operating time). If so configured, the timer 136 is configured to track one or more times at a single time. The exemplary timer 136 can also be configured to communicate times, as well as receive instructions to start tracking a time period, from the controller 122. For example, the timer 136 is configured to notify the controller 122 of the time when the controller 122 sends a signal (e.g., voltage, current) to turn on or off a lighting device 140. As another example, the timer 136 is configured to measure a period of time from when a lighting device 140 is turned on to when the lighting device 140 is turned off The timer 136 can track time in meridians (a.m., p.m.) and/or in military time.

The optional battery 114 of the electrical switch device 120 can be used to provide power to one or more components of the electrical switch device 120 when power from the power supply 110 ceases. For example, if power provided from the power supply 110 is cut off or otherwise interrupted, the battery 114 can provide power to the timer 136 until the power from the power supply 110 resumes. In such a case, the clock time kept by the timer 136 continues to count, using the battery 114, rather than being reset when the power from the power supply 110 resumes.

The battery 114 can provide any voltage (e.g., 3V, 9V, 12V) and/or current, and have any size suitable for providing power to the one or more components of the electrical switch device and/or being positioned within the housing 102. The battery 114 can be replaceable or non-replaceable. In certain exemplary embodiments, the battery 114 is rechargeable. For example, the battery 114 can be recharged by the power provided from the power supply 110 when the battery 114 is not needed or used.

The optional sensor 112 of the electrical switch device 120 can be used to detect occupancy within a space (also called an occupancy condition). A space is any area that may be occupied by one or more people. The space can be within a structure (e.g., building, office, garage) or outside of a structure. Each exemplary sensor 112 can be communicably coupled to the hardware processor 124. The sensor 112 can be located within and/or on an outer surface of the housing 102 of the electrical switch device 120. Alternatively, the sensor 112 can be located remotely from the housing 102. The sensor 112 can be a physical device, a circuit that includes one or more of a number of discrete components (e.g., resistor, capacitor), an integrated circuit, software (as executed by the hardware processor 124, for example), or any suitable combination thereof.

The sensor 112 can be a separate (stand-alone) component of the electrical switch device 120. Alternatively, the sensor 112 can be combined with some other component or device. For example, the sensor 112 can be positioned on a separate electrical switch device that is communicably coupled with the electrical switch device 120. As another example, the sensor 112 can be integrated with the slider on a sliding dimming switch on the front surface of the housing 102 of the electrical switch device 120.

In certain exemplary embodiments, the sensor 112 uses one or more types of sensing technology to generate a signal that indicates an occupancy condition (i.e., whether the space is occupied). A sensor 112 may operate continuously, on a random basis, on a periodic basis, or any suitable combination thereof. There are various types of sensing technologies for a sensor 112. Examples of sensing technologies for a sensor 112 include ultrasonic, infrared, microwave, and microsonic. A type of sensing technology may include multiple categories. For example, infrared technology may include passive infrared (PIR). A sensor 112 may use one or more sensing technologies. For example, a sensor 112 is capable of using both ultrasonic and infrared technologies.

Regardless of the sensing technology used by a sensor 112, the sensor 112 may operate in a certain manner (e.g., send a signal to the hardware processor 124, cease sending a signal to the hardware processor 124) based on one or more occupancy conditions. For example, the sensor 112 sends a signal to the hardware processor 124 when the sensor 112 detects that an occupancy condition exists in a space. As another example, the sensor 112 ceases sending a signal to the hardware processor 124 when the sensor 112 detects that an occupancy condition exists in the space. As yet another example, the sensor 112 sends a signal to the hardware processor 124 when the sensor 112 detects that an occupancy condition ceases to exist in the space. For another example, the sensor 112 ceases sending a signal to the hardware processor 124 when the sensor 112 detects that an occupancy condition ceases to exist in the space. In certain exemplary embodiments, each signal sent by the sensor 112 to the hardware processor 124 is different to designate a different occupancy condition.

In certain exemplary embodiments, the sensor 112 overrides the control switch 130. For example, when the control switch 130 is in the enabled state and the light switch 132 is in the off position, if the sensor 112 is a motion sensor that detects motion, then the lighting device 140 can be turned on. Such can be the case even if the usage history 144 of the lighting device 140 dictates that the lighting device 140 should be off at that time of day while the control switch 130 is in the enabled state.

In other words, in certain exemplary embodiments, if the sensor 112 is activated, the sensor 112 can toggle the control switch 130 from the enabled state to the disabled state. Alternatively, if the sensor 112 is activated while the control switch 130 is in the enabled state, the control switch 130 can remain in the enabled state, but allow the activated sensor 112 to determine the output to the lighting device 140 until the usage history 144, for the subsequent time of day as determined by the timer 136, dictates that the hardware processor 124, using the controller 122, changes the state of the lighting device 140. In yet another exemplary embodiment, the sensor 112 is ignored when the control switch 130 is in the enabled state.

The sensor 112 can also, or in the alternative, detect ambient light. In such a case, the sensor 112 can be used to help determine the time of day if power provided to the timer 136 (either by the power supply 110 and/or the battery 114) is interrupted and later resumed. When resumed, the timer 136 may default to a start time (e.g., midnight). By using the sensor 112 to detect an amount of ambient light, the hardware processor 124 can set the timer 136 to a time other than the default time of the timer 136 when the power to the timer 136 resumes.

The optional randomizer 116 of the electrical switch device 120 can be used to override the usage history 144 stored in the storage repository 138 and instruct the controller 122 (through the hardware processor 130) to operate a one lighting device 140 when the control switch 130 is in the enabled state. In certain exemplary embodiments, the randomizer 116 is disabled when the control switch 130 is in the disabled state and can only be enabled when the control switch 130 is in the enabled state. The randomizer 116 can be operatively coupled to the hardware processor 124.

The randomizer 116 can be located within the housing 102 of the electrical switch device 120. Alternatively, the randomizer 116 can be located remotely from the housing 102. The randomizer 116 can be a physical device (e.g., a switch), a circuit that includes one or more of a number of discrete components (e.g., resistor, capacitor), an integrated circuit, software (as executed by the hardware processor 124, for example), or any suitable combination thereof. The randomizer 116 can be enabled by a user 150, according to a default setting, upon the occurrence of an event (e.g., passage of time, time of day), and/or based on some other factor.

In certain exemplary embodiments, the randomizer 116 is only used when one or more of a number of certain conditions exist. Examples of such conditions can include, but are not limited to, loss of power from the power supply 110, there is no battery 114, the battery 114 is not providing back-up power to the timer 136, the control switch 130 is in the enabled state, there is no sensor 112, the sensor 112 is not detecting ambient light, and the light source 130 is currently illuminated. For example, the randomizer 116 may operate only when power from the power supply 110 ceases, when the battery 114 is not providing back-up power to the timer 136, and when the sensor 112 cannot detect ambient light. In such a case, the timer 136 cannot determine what time it currently is.

FIGS. 2 through 2C-2 show various views of various exemplary electrical switch devices in accordance with one or more embodiments. Specifically, FIG. 2 shows a perspective view of an exemplary control switch 130. FIG. 2A shows a front view of an exemplary electrical switch device 200 having a light switch 232 disposed on the outer surface of the housing 250. FIG. 2B shows a front view of another exemplary electrical switch device 200 having two light switches (light switch 232 and light switch 233) disposed on the outer surface of the housing 250. FIG. 2C-1 shows a perspective view of yet another exemplary electrical switch device 200 having a switch 234 that combines a light switch 250 and a control switch 252, where FIG. 2C-2 shows a perspective view of an exemplary control switch 130.

Referring now to FIGS. 1, 2, and 2A, the exemplary electrical switch device 200 includes a wall plate 202 having an aperture that exposes the light switch 232. In this example, the light switch 232 is a two-pole switch that toggles between settings by applying pressure on a protruding top end 208. In such a case, when the protruding top end 208 is depressed, the bottom end 206, which is hingedly coupled to the top end 208 around a horizontal axis 207, protrudes.

The wall plate may couple to the housing 250 in one or more of a number of ways, including but not limited to an interlocking snap and a fastening device (e.g., a screw) (not shown). In one or more exemplary embodiments, the dimensions of the wall plate 202 may be any suitable length, width, and/or height. For example, the dimensions of the wall plate 202 for a single gang outlet box are approximately 4¼ inches high and 2¾ inches wide. The wall plate 202 may also be oversized relative to a single gang combination device.

The aperture in the wall plate 202 that exposes the portion of the light switch 232 may be any suitable size (width, height) to allow a user 150 to interact with (e.g., provide manual adjustment access to) the settings of the light switch 232. For example, the aperture in the wall plate 202 may be approximately the same size as the protruding portion of the light switch 232 to secure the light switch 232. In certain exemplary embodiments, the aperture in the wall plate 202 is at least as large as the top portion of the light switch 232.

The front panel of the wall plate 202 (the portions of the wall plate 202 between the aperture and the outer edges of the wall plate 202) may be of sufficient height/width to secure (for example, by extending over a least a portion of) the light switch 232 to the rest of the housing 250 of the electrical switch device 200. The wall plate 202 may be made of one or more of a number of suitable materials, including but not limited to metal and plastic.

The wall plate 202 of FIG. 2A also includes an aperture through which a sensor 112 protrudes. The sensor 112 can detect a level of ambient light and/or motion. In addition, the control switch 130 (shown in FIG. 2) is accessible by removing the wall plate 202 from the housing 250. In certain exemplary embodiments, when the wall plate 202, the sensor 112, and the light switch 232 are removable, the assembly of the wall plate 202, the sensor 112, and the light switch 232 is called a faceplate.

FIG. 2B shows a top view of another exemplary electrical switch device 220. Referring now to FIGS. 1-2B, the exemplary electrical switch device 220 includes a wall plate 203 that is substantially similar to the wall plate 202 of FIG. 2A, except that the wall plate 203 in FIG. 2B includes an additional aperture through which a second light switch 233 protrudes. In this example, the second light switch 233 is a sliding dimmer switch that has a number of non-discrete dimmer settings.

To adjust the dimmer level on the light switch 233, the user 150 moves the slide 226 along the channel 224. When the slide 226 is at the bottom of the channel 224, as shown in FIG. 2B, the dimmer setting is at the lowest dimmer level. When the slide 226 is at the top of the channel 224, the dimmer setting is at the highest dimmer level. When the user 150 positions the slide 226 at any other point along the channel 224, the dimmer setting is set proportionately to the distance (e.g., as a percentage) from the top end of the channel 224. In addition, as in FIG. 2A, the control switch 130 is accessible by removing the wall plate 203 from the housing 251.

FIG. 2C-1 shows a perspective view of another exemplary electrical switch device 240, and FIG. 2C-2 shows a perspective view of an exemplary control switch 130. Referring now to FIGS. 1 through 2C-2, the exemplary electrical switch device 240 lacks the wall plate shown in FIGS. 2A and 2B. Instead, the exemplary device 240 shown in FIG. 2C includes a switch 234 that combines a light switch 250 with a control switch 252, the sensor 112, a blank 235, a mounting strap 246, and a bottom housing 248 (also called an outlet box).

In certain exemplary embodiments, the combination of the switch 234, the sensor 112, and the blank 235 mates with and/or couples to the wall plate. For example, the raised profile of the combination of the switch 234, the sensor 112, and the blank 235 may be of a slightly smaller size than the aperture of the wall plate. The switch 234, the sensor 112, and the blank 235 can be made of one or more of a number of suitable materials, including but not limited to metal, glass, rubber, and plastic.

The switch 234 shown in FIG. 2C-1 includes a light switch 250 that is a pushbutton surrounded by a depressible control switch 252. In certain exemplary embodiments, there can be multiple components of the control switch. For example, as shown in FIG. 2C-1, part of the control switch 130 can positioned inside the housing 253 in such a manner that, when the control switch 252, disposed on the outer surface of the housing 253, is depressed (e.g., press and hold for at least 2 seconds), the control switch 130 changes state (toggles from the enabled state to the disabled state or from the disabled state to the enabled state).

The blank 235 fills the space in the aperture of the wall plate not filled by the switch 234 and the sensor 112. The blank 235 can be purely decorative with no functional purpose. Alternatively, the blank 235 can include one or more features, including but not limited to a light, an outlet, and another sensor (e.g., a motion sensor). The blank can be made of one or more of a number of suitable materials, including but not limited to plastic, glass, and metal.

In one exemplary embodiment, the mounting strap 246 is configured to secure the device 240 to a wall or other surface. In some exemplary embodiments, the mounting strap 246 is also, or in the alternative, configured to receive a fastening mechanism to couple the mounting strap 246 to the wall plate and/or the bottom housing 248. Such a fastening mechanism may include, but is not limited to, an interlocking snap and a fastening device (e.g., a screw). The exemplary mounting strap 246 has a solid body. Alternatively, the exemplary mounting strap 246 has one or more apertures in its body (as shown in FIG. 2C), for example, to allow wiring to pass through the body of the mounting strap 246. The mounting strap 246 can be made of one or more of a number of suitable materials, including but not limited to metal, glass, rubber, and plastic.

The exemplary bottom housing 248 includes a back surface and a number of side surfaces that define a cavity that houses (receives) wires (e.g., a power and/or control cable), a battery 114, the hardware processor 124, a randomizer 116, a circuit board, and/or any other electrical component. The bottom housing 248 may also be used to mount to a wall or other surface. The exemplary bottom housing 248 may further be configured to couple to the mounting strap 246 in one or more of a number of ways, including but not limited to snap fittings and fastening devices (e.g., screws).

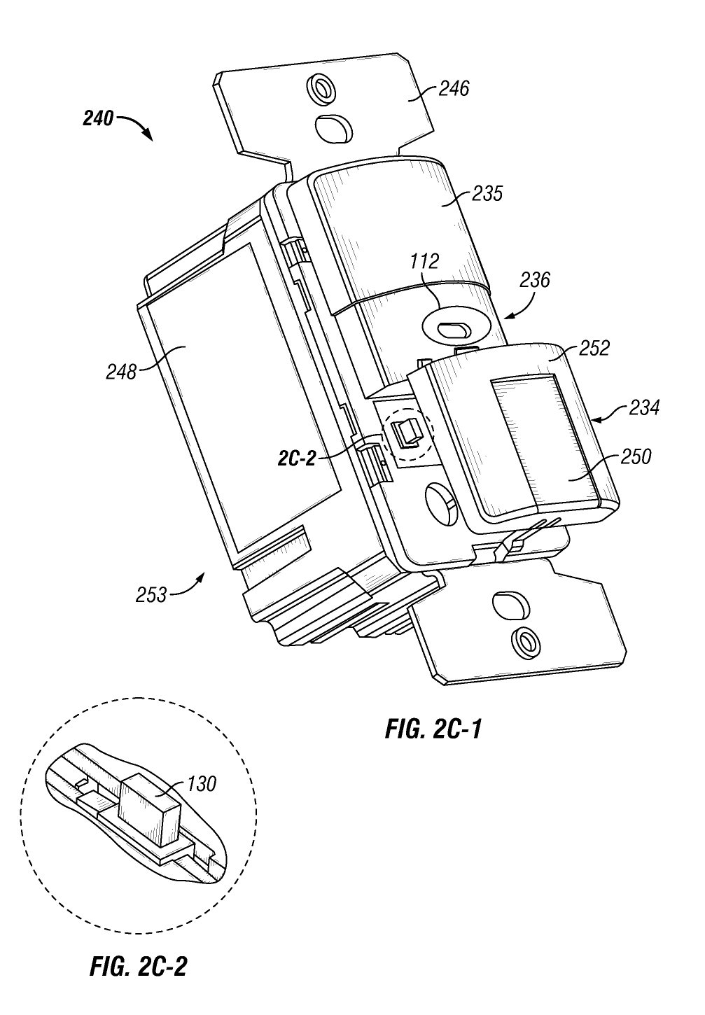

FIG. 3 is a flowchart of a method 300 for controlling a lighting device with an exemplary electrical switch device in accordance with one or more exemplary embodiments. While the various steps in this flowchart are presented and described sequentially, one of ordinary skill will appreciate that some or all of the steps may be executed in different orders, may be combined or omitted, and some or all of the steps may be executed in parallel. Further, in one or more of the exemplary embodiments, one or more of the steps described below may be omitted, repeated, and/or performed in a different order.

In addition, a person of ordinary skill in the art will appreciate that additional steps not shown in FIG. 3, may be included in performing this method. Accordingly, the specific arrangement of steps should not be construed as limiting the scope. In addition, a particular computing device, as described, for example, in FIG. 4 below, may be used to perform one or more of the steps for the method 300 described below.

Now referring to FIGS. 1-3, the exemplary method 300 begins at the START step and proceeds to step 302, where the usage of a lighting device 140 is tracked. In one or more exemplary embodiments, the usage of the lighting device 140 is tracked by the hardware processor 124, using the timer 136. The usage can be tracked for a single lighting device 140 or, if multiple lighting devices 140 are operated from a single electric lighting device 120, for each or a combination of the multiple lighting devices 140.

In step 304, a usage history 144 of the lighting device 140 is compiled. The usage history 144 is based on the usage of the lighting device 140. In exemplary embodiments, the usage history 144 for the lighting device 140 is compiled by the hardware processor 124 based on instructions stored in the memory 126. The usage history is compiled regardless of the state (enabled state, disabled state) of the control switch 130. When multiple lighting devices 140 are controlled by the electric lighting device 120, the usage history 144 for each lighting device 140 can be kept separately from the other lighting devices. Alternatively, the usage history 144 for all of the lighting devices 140 can be combined into a single usage history 144.

In step 306, an enablement signal is received from a user 150. The enablement signal is received by the hardware processor 124. In certain exemplary embodiments, the enablement signal is sent by the control switch 130 when the control switch 130 is toggled by the user 150 from the disabled state to the enabled state. The usage of the lighting device 140 can continue to be tracked (as described above with respect to step 302) after the enablement signal is received by the hardware processor 124 from the control switch 130.

In step 308, the lighting device 140 is operated according to the usage history 144. In certain exemplary embodiments, the lighting device 140 is operated by the controller 122, which is directed by the hardware processor 124. The hardware processor 124 determines that the lighting device 140 should be turned on or off at a particular time (as determined by the timer 136) based on one or more algorithms, stored in memory 126, that make calculations based on the usage history 144. The process then continues to the END step.

In one or more exemplary embodiments, the usage is tracked, and a usage history 144 is compiled by the hardware processor 124 and stored in the storage repository 138, even if the control switch 130 is never set to the enabled state. Further, the hardware processor 124 can generate and/or modify an algorithm to determine when a lighting device 140 is turned on and off when the control switch 130 is enabled, even if the control switch 130 is never set to the enabled state.

FIG. 4 illustrates one embodiment of a computing device 400 capable of implementing one or more of the various techniques described herein, and which may be representative, in whole or in part, of the elements described herein. Computing device 400 is only one example of a computing device and is not intended to suggest any limitation as to scope of use or functionality of the computing device and/or its possible architectures. Neither should computing device 400 be interpreted as having any dependency or requirement relating to any one or combination of components illustrated in the example computing device 400.

Computing device 400 includes one or more processors or processing units 402, one or more memory/storage components 404, one or more input/output (I/O) devices 406, and a bus 408 that allows the various components and devices to communicate with one another. Bus 408 represents one or more of any of several types of bus structures, including a memory bus or memory controller, a peripheral bus, an accelerated graphics port, and a processor or local bus using any of a variety of bus architectures. Bus 408 can include wired and/or wireless buses.

Memory/storage component 404 represents one or more computer storage media. Memory/storage component 404 may include volatile media (such as random access memory (RAM)) and/or nonvolatile media (such as read only memory (ROM), flash memory, optical disks, magnetic disks, and so forth). Memory/storage component 404 can include fixed media (e.g., RAM, ROM, a fixed hard drive, etc.) as well as removable media (e.g., a Flash memory drive, a removable hard drive, an optical disk, and so forth).

One or more I/O devices 406 allow a customer, utility, or other user to enter commands and information to computing device 400, and also allow information to be presented to the customer, utility, or other user and/or other components or devices. Examples of input devices include, but are not limited to, a keyboard, a cursor control device (e.g., a mouse), a microphone, and a scanner. Examples of output devices include, but are not limited to, a display device (e.g., a monitor or projector), speakers, a printer, and a network card.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media may be any available non-transitory medium or non-transitory media that can be accessed by a computing device. By way of example, and not limitation, computer readable media may comprise “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The computer device 400 may be connected to a network (not shown) (e.g., a local area network (LAN), a wide area network (WAN) such as the Internet, or any other similar type of network) via a network interface connection (not shown). Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means may take other forms, now known or later developed. Generally speaking, the computer system 400 includes at least the minimal processing, input, and/or output means necessary to practice one or more embodiments.

Further, those skilled in the art will appreciate that one or more elements of the aforementioned computer device 400 may be located at a remote location and connected to the other elements over a network. Further, one or more exemplary embodiments may be implemented on a distributed system having a plurality of nodes, where each portion of the implementation (e.g., controller 122, randomizer 116) may be located on a different node within the distributed system. In one or more embodiments, the node corresponds to a computer system. Alternatively, the node may correspond to a processor with associated physical memory. The node may alternatively correspond to a processor with shared memory and/or resources.

The following description (in conjunction with FIGS. 1 through 4) describes an example in accordance with one or more exemplary embodiments. The example is for explanatory purposes only and is not intended to limit the scope. Terminology used in FIGS. 1-4 may be used in the example without further reference to those figures.

### EXAMPLE

Referring to FIGS. 1-5, consider the following example of a system 500 using an exemplary electrical switch device in a housing 102, as described above. As shown in FIG. 7, the control switch 130 is initially in the disabled state 502, and the lighting device 140 is off 505. The lighting device 140 has a usage history 144, stored in the storage repository 138, as shown in the following table:

| Number of | | | |
|---|---|---|---|
| operations | Start Time | End Time | Dimmer Level |
| 1 | 18:30 | 23:00 | 100% |
| 2 | 18:06 | 22:22 | 100% |
| 3 | 19:02 | 22:46 | 100% |
| 4 | 18:15 | 23:24 | 100% |
| 5 | 18:56 | 22:53 | 100% |
| 6 | 19:32 | 23:11 | 100% |
| 7 | 17:59 | 22:44 | 100% |
| 8 | 18:37 | 22:58 | 100% |
| 9 | 17:42 | 21:56 | 100% |
| 10 | 18:31 | 22:52 | 100% |

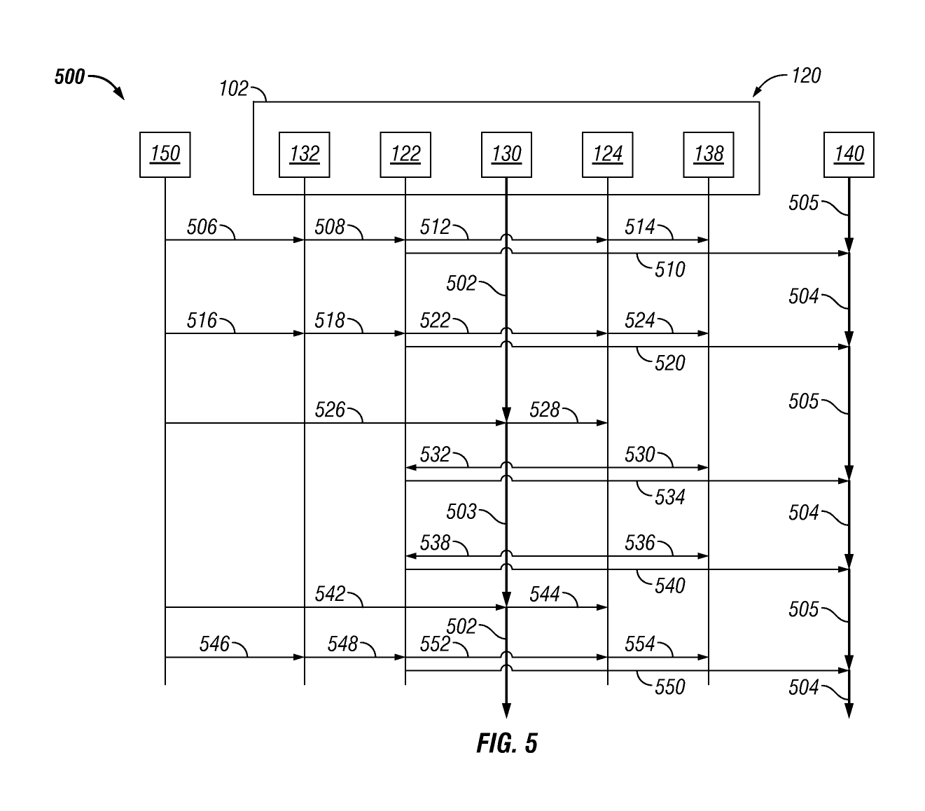

The tenth operation shown in the table above is shown in FIG. 5. Specifically, at 18:31 on a given day, the user 150 turns on 506 the light switch 132 disposed on an outer surface of the housing 102 of the electrical switch device 120. Once the light switch 132 is turned on, the light switch 132 sends a signal 508 to the controller 122 to instruct the controller 122 to turn on the lighting device 140. When the controller 122 receives the signal 508, the controller 122 sends a signal 510 (e.g., voltage, current) to the lighting device 140, which turns on 504 the lighting device 140. Simultaneously with sending signal 508 to the lighting device 140, the controller 122 also sends signal 512 to the hardware processor 124, which sends a signal 514 to the storage repository 138 to initiate a usage record for the usage history 144 of the lighting device 140.

At 22:52, the user 150 turns off 516 the light switch 132 of the electrical switch device 120. Once the light switch 132 is turned off, the light switch 132 sends a signal 518 to the controller 122 to instruct the controller 122 to turn off the lighting device 140. When the controller 122 receives the signal 518, the controller sends a signal 520 to the lighting device 140, which turns off 505 the lighting device 140. In other words, the controller 122 stops sending power to the lighting device 140. Simultaneously with sending signal 518 to the lighting device 140, the controller 122 also sends signal 522 to the hardware processor 124, which ends 524 the current usage record in the storage repository 138 for the usage history 144 of the lighting device 140.

At some subsequent point in time, the user 150 toggles 526 the control switch 130 to the enabled state 503 from the disabled state 502. When the control switch 130 is toggled 526, the control switch 130 sends an enablement signal 528 to the hardware processor 124. The enablement signal 528 allows the hardware processor 124 to control the controller 122.

With the control switch 130 in the enabled state 503, the hardware processor 124 uses the usage history 144 and one or more algorithms, all stored in the storage repository 138, to determine when the lighting device 140 should be turned on. In this case, the usage history is shown in the table above. The algorithm in this example calculates a simple average to determine the start time, the end time, and the dimmer level. Using the algorithm, the hardware processor 124 calculates that the start time is 18:28, the end time is 22:49, and the dimmer level is 100%.

The first time after the control switch 130 is in the enabled state 503 that the timer 136 determines that the time is 18:28, the hardware processor 124 sends a signal 532 to the controller 122, which in turn sends a signal 534 to the lighting device 140 to turn on at a dimmer level of 100%. Simultaneously to the hardware processor 124 sending the signal 532 to the controller 122, the hardware processor 124 sends another signal 530 to the storage repository 138 to initiate a usage record for the usage history 144 of the lighting device 140. In the table of the usage history 144 above, a new row would be populated for the 11^{th} operation of the lighting device 140, with a start time of 18:28 and a dimmer level of 100%.

At 22:49, as measured by the timer 136, the hardware processor 124 sends a signal 538 to the controller 122, which in turn sends a signal 540 to the lighting device 140 to turn off. In other words, the controller 122 stops sending power to the lighting device 140. Simultaneously to the hardware processor 124 sending the signal 538 to the controller 122, the hardware processor 124 sends another signal 536 to the storage repository 138 to terminate the usage record for the usage history 144 of the lighting device 140. In the table of the usage history 144 above, end time for the 11^{th} operation of the lighting device 140 is entered as 22:49.

At some subsequent point in time, before the next occurrence of a reading of 18:28 by the timer 136, the user 150 toggles 542 the control switch 130 to the disabled state 502 from the enabled state 503. When the control switch 130 is toggled 542, the control switch 130 sends a disablement signal 544 to the hardware processor 124. The disablement signal 544 terminates the control of the hardware processor 124 over the controller 122 so that the controller 122 is controlled by the light switch 132.

At some subsequent point in time, the user 150 turns on 546 the light switch 132 of the electrical switch device 120. Once the light switch 132 is turned on, the light switch 132 sends a signal 548 to the controller 122 to instruct the controller 122 to turn on the lighting device 140. When the controller 122 receives the signal 548, the controller 122 sends a signal 550 to the lighting device 140, which turns on 504 the lighting device 140. Simultaneously with sending signal 548 to the lighting device 140, the controller 122 also sends signal 552 to the hardware processor 124, which sends a signal 554 to the storage repository 138 to initiate a usage record for the usage history 144 of the lighting device 140. This usage record is recorded as the 12^{th} operation of the lighting device 140 in the table of the usage history 144.

Exemplary embodiments described herein are directed to combination devices. Using exemplary embodiments, a wide array of functionality (e.g., controlling, monitoring) with regard to one or more lighting devices is achieved in a constrained space. Exemplary embodiments replace the use of external timers and security devices by merely making adjustments to the software installed within such devices.

In one or more exemplary embodiments, multiple lighting devices (e.g., lighting fixture, ceiling fan) can be controlled using a single exemplary electrical switch device. The use of a simple control switch increases the ease for the user to enable and disable the functionality of the exemplary electrical switch device.

Because of the ease with which a user can have one or more lighting devices turn on and off when the user is not present, the building in which the user works and/or resides can be more secure by deterring potential criminals. The deterrence provided by exemplary electrical switch devices described herein can be turning on and off certain lighting devices when the user is not present, according to the user's usage history and/or according to a randomly selected time schedule.

Although embodiments described herein are made with reference to exemplary embodiments, it should be appreciated by those skilled in the art that various modifications are well within the scope and spirit of this disclosure. Those skilled in the art will appreciate that the exemplary embodiments described herein are not limited to any specifically discussed application and that the embodiments described herein are illustrative and not restrictive. From the description of the exemplary embodiments, equivalents of the elements shown therein will suggest themselves to those skilled in the art, and ways of constructing other embodiments using the present disclosure will suggest themselves to practitioners of the art. Therefore, the scope of the present invention is not limited herein.

We claim:

1. An electrical switch device, comprising:
a housing having a plurality of walls forming a cavity;
a controller positioned within the cavity and used to operate at least one lighting device external to the housing;
a storage repository that stores a usage history for the at least one lighting device;
memory positioned within the cavity, wherein the memory stores a plurality of instructions;
a timer that tracks time;
a hardware processor for executing the plurality of instructions stored in the memory, wherein the hardware processor is positioned within the cavity and is operatively coupled to the memory, the timer, and the controller; and
a control switch operatively coupled to the controller and the hardware processor, wherein the control switch has an enabled state and a disabled state, wherein the enabled state allows the hardware processor to control the controller based on the usage history, and wherein the disabled state allows the controller to be controlled by a user.

2. The electrical switch device of claim 1, wherein, when the control switch is in the enabled state, the hardware processor controls the controller based on the usage history stored in the storage repository, wherein the hardware processor determines, based on the plurality of instructions, the usage history.

3. The electrical switch device of claim 1, wherein the control switch is positioned within the cavity.

4. The electrical switch device of claim 1, wherein the control switch is disposed on an outer front surface of the housing.

5. The electrical switch device of claim 1, wherein the usage history is stored in the storage repository when the control switch is in the enabled state and when the control switch is in the disabled state.

6. The electrical switch device of claim 5, wherein the usage history is based on when the at least one lighting device is operated.

7. The electrical switch device of claim 1, further comprising:
a sensor operatively coupled to the hardware processor, wherein the sensor that detects an amount of ambient light,
wherein the hardware processor uses a signal from the sensor to set the timer based on the amount of ambient light detected by the sensor.

8. The electrical switch device of claim 1, further comprising:
a battery electrically coupled to the timer, wherein the battery provides a first power to the timer when a second power provided to the timer by a power source is interrupted.

9. The electrical switch device of claim 1, further comprising:
a randomizer operatively coupled to the hardware processor, wherein the randomizer overrides the usage history and instructs the controller to operate the at least one lighting device when the control switch is in the enabled state.

10. The electrical switch device of claim 9, wherein the randomizer is enabled when the control switch is in the enabled state.

11. The electrical switch device of claim 1, wherein the controller comprises a dimmer, wherein the dimmer adjusts the amount of power delivered to the at least one lighting device.

12. The electrical switch device of claim 11, wherein the usage history includes a level of output at which the at least one lighting device is operated.

13. The electrical switch device of claim 1, wherein the controller comprises a light switch, wherein the light switch toggles between providing full power to the at least one lighting device and no power to the at least one lighting device.

14. The electrical switch device of claim 1, wherein the controller comprises a motion sensor, wherein the motion sensor determines whether a space is occupied.

15. The electrical switch device of claim 1, wherein the enabled state of the control switch further enables the user to control the controller, wherein user instructions delivered by the user to the controller when the control switch is in the enabled state supercede hardware processor instructions delivered by the hardware processor to the controller.

16. The electrical switch device of claim 15, wherein the hardware processor adjusts, based on a current usage that differs from a historical usage of the at least one lighting device and based on the plurality of instructions, the usage history.

17. A method for controlling a lighting device, the method comprising:
tracking a usage of the lighting device;
compiling, based on the usage, a usage history of the lighting device;
receiving an enablement signal from a user; and
operating, using a hardware processor, and based on the enablement signal, the lighting device according to the usage history.

18. The method of claim 17, further comprising:
continuing to track the usage of the lighting device after receiving the enablement signal.

19. A computer readable medium comprising computer readable program code embodied therein for performing a method for controlling a lighting device, the method comprising:
tracking a usage of the lighting device;
compiling, based on the usage, a usage history of the lighting device;
receiving an enablement signal from a user; and
operating, based on the enablement signal, the lighting device according to the usage history.

20. The computer readable medium of claim 19, the method further comprising:
adjusting, based on a current usage that differs from a historical usage of the lighting device, the usage history.
